(19) United States
(12) Patent Application Publication
(10) Pub. No.: US 2025/0136405 A1
(43) Pub. Date: May 1, 2025

(54) CABLE MANAGEMENT DRIVE SYSTEM FOR INDUSTRIAL ROBOTS

(71) Applicant: Lockheed Martin Corporation, Bethesda, MD (US)

(72) Inventors: Christopher Sean McCrory, Fort Worth, TX (US); Jeffrey T. Drewett, Fort Worth, TX (US); Adam Michael Stephens, Fort Worth, TX (US); Carl T. Smith, Fort Worth, TX (US)

(21) Appl. No.: 18/499,907

(22) Filed: Nov. 1, 2023

(51) Int. Cl. B65H 75/36

(52) U.S. Cl. CPC B65H 75/362

(57) ABSTRACT

A cable management drive system for extending and retracting cable bundles is provided. The cable management drive system includes a cable bundle configured to provide power signals or data signals to an industrial robot configured to perform a service. The cable bundle is configured to couple to the industrial robot. The cable management drive system includes a plurality of drive wheels coupled to a drive mechanism and configured to cause the cable bundle to be extended to facilitate a deployment of the industrial robot to perform the service and to be retracted to facilitate a withdrawal of the industrial robot upon performance of the service, and a driver system coupled to the plurality of drive wheels and the drive mechanism. The driver system is configured to power the drive wheels and the drive mechanism to cause the cable bundle to be extended and retracted.

### TECHNICAL FIELD

This disclosure relates generally to industrial robots, and, more specifically, to a cable management drive system for industrial robots.

### BACKGROUND

Industrial robots utilized in manufacturing and production facilities or other similar industrial settings (e.g., processing plants, construction sites) may generally include a six-axis, mobile robotics platform. In many instances, due to the complex movements and maneuvers performed by such six-axis, mobile industrial robots, effective cable management often proves to be the most imperative aspect of any application utilizing mobile industrial robots. For example, although cables for mobile industrial robots may themselves be suitable for withstanding the complex movements and maneuvers of the mobile industrial robots, without effective cable management, the cables may prematurely wear, damage, or otherwise cause the mobile industrial robot to become temporarily inoperable. Additionally, ineffective cable management may often lead to cables obstructing the work path of the mobile industrial robot or entangling the moving parts of the mobile industrial robot.

### BRIEF DESCRIPTION OF THE DRAWINGS

FIG. 1 illustrates an example storage container and cable management drive system.

FIG. 2 illustrates an example cable management drive and control system.

FIG. 3 flow diagram of a method for providing a cable management drive system for efficiently extending and retracting cable bundles.

FIG. 4 illustrates an example computer system.

### DESCRIPTION OF EXAMPLE EMBODIMENTS

### Overview

The present embodiments are directed to techniques for providing a cable management drive system for efficiently extending and retracting cable bundles of mobile industrial robots. In particular embodiments, the cable management drive system may include a cable bundle that may be configured to provide one or more power signals, data signals, or utility signals to an industrial robot utilized to perform a manufacturing service. In one embodiment, the cable bundle may be configured to couple to the industrial robot. For example, in particular embodiments, the cable bundle may include one or more long tubular multi-axis cable carriers.

In particular embodiments, the cable management drive system may further include a number of drive wheels coupled to a drive mechanism and configured to cause the cable bundle to be extended and retracted. For example, in one embodiment, the cable bundle may be extended to facilitate a deployment of the industrial robot to perform the manufacturing service. In another embodiment, the cable bundle may be retracted to facilitate a withdrawal of the industrial robot upon performance of the manufacturing service. In particular embodiments, the cable management drive system may further include a driver system coupled to the number of drive wheels and the drive mechanism. For example, in particular embodiments, the driver system may be configured to power the number of drive wheels and the drive mechanism to cause the cable bundle to be extended and retracted.

In some embodiments, the driver system may include a manual crank mechanism. In other embodiments, the driver system may include a motor. In particular embodiments, the cable management drive system may further include a number of release levers that may be configured to dynamically deactivate the number of drive wheels to allow manual operation of the drive system. In particular embodiments, the cable management drive system may further include a storage container. For example, in one embodiment, the cable bundle may be configured to extend from the storage container and to retract into the storage container. In particular embodiments, the industrial robots may include a mobile industrial robot. In particular embodiments, the storage container may be coupled to the mobile industrial robot by way of the cable bundle. For example, in one embodiment, the storage container may enclose the cable management drive system.

Technical advantages of particular embodiments of this disclosure may include one or more of the following. Certain systems and methods described herein provide a cable management drive system suitable for efficiently extending and retracting cable bundles (e.g., long tubular multi-axis cable carriers) associated with mobile industrial robots as illustrated. The cable management drive system may be enclosed within a storage container, and further includes: drive wheels coupled with a drive mechanism and configured to cause the cable bundles (e.g., long tubular multi-axis cable carriers) to be extended or retracted; release levers configured to dynamically deactivate the drive wheels and allow for operators to manually extend the cable bundles (e.g., long tubular multi-axis cable carriers); and a motor or manual crank, attached to the drive wheels and drive mechanism, and configured to power the drive wheels and drive mechanism to cause the cable bundles (e.g., long tubular multi-axis cable carriers) to be extended or retracted. In this way, the present embodiments thus allow for mobile robots including cable bundles (e.g., long tubular multi-axis cable carriers) to be efficiently and compactly deployed.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

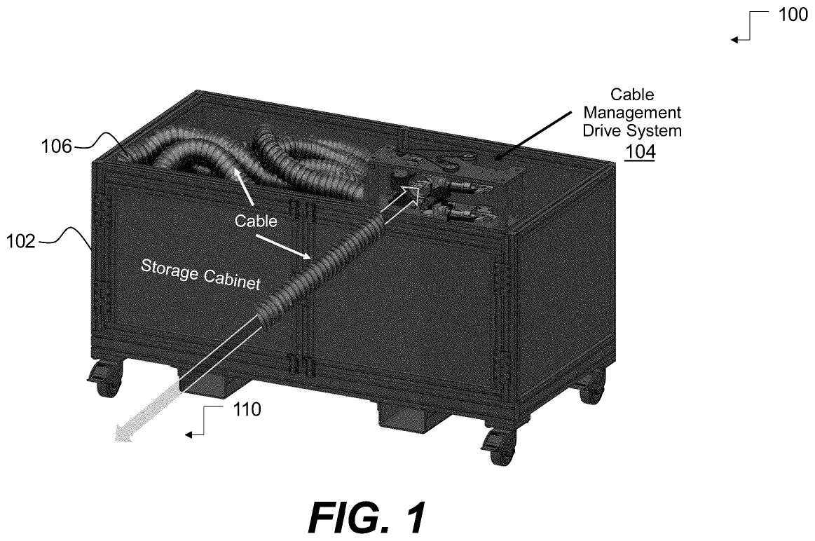

FIG. 1 illustrates an example storage container and cable management drive system 100, in accordance with the presently disclosed embodiments. As depicted, in particular embodiments, the storage container and cable management drive system 100 may include a storage container 102, which may enclose a cable management drive system 104 and a cable bundle 106. In particular embodiments, the storage container 102 may include any stationary or mobile enclosure that may be suitable for wholly containing the cable management drive system 104 and the cable bundle 106. In particular embodiments, the storage container 102 may be sized according to a length of the cable bundle 106. Similarly, in particular embodiments, the cable management drive system 104 may be sized according to a diameter of the cable bundle 106.

In particular embodiments, although not illustrated, the storage container 102, including the cable management drive system 104 and the cable bundle 106, may be coupled to a mobile industrial robot (e.g., six-axis, mobile industrial robots) that may be utilized to perform one or more manufacturing and production services within an industrial setting (e.g., manufacturing and production facility, processing plant, construction site, and so forth). In particular embodiments, the cable management drive system 104 may include a system suitable for efficiently extending and retracting the cable bundle 106. For example, in one embodiment, the cable bundle 106 may include one or more long tubular multi-axis cable carriers that may be utilized to provide one or more power signals (e.g., electric power signals), data signals (e.g., communications signals, controls signals, and so forth), or utility signals (e.g., pneumatic, vacuum, paint, hydraulic, and so forth) to the mobile industrial robot.

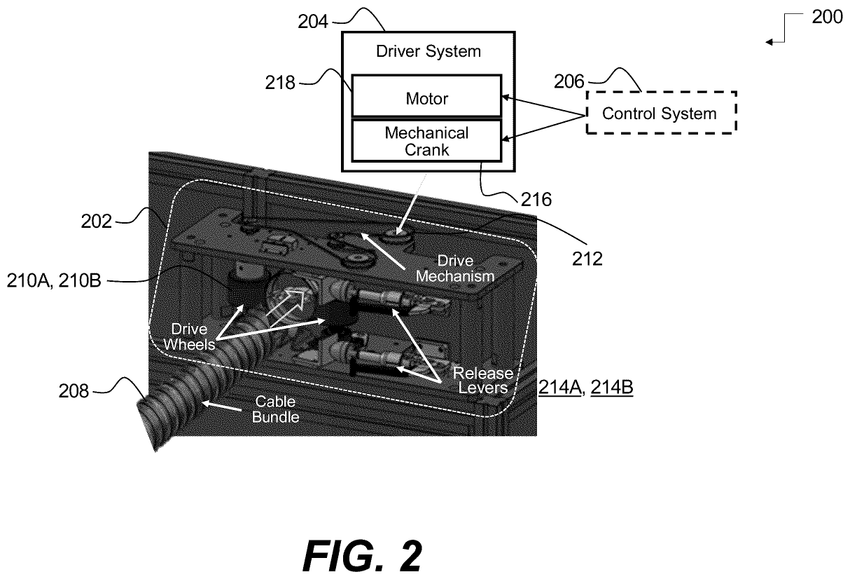

FIG. 2 illustrates an example cable management drive and control system 200, in accordance with the presently disclosed embodiments. As depicted, in particular embodiments, the cable management drive and control system 200 may include cable management drive system 202, a driver system 204, and a control system 206. In particular embodiments, the cable management drive system 202 may include a cable bundle 208 that may be utilized to provide one or more power signals or data signals to a mobile industrial robot in accordance with the presently disclosed embodiments. For example, in one embodiment, the cable bundle 208 may couple to the mobile industrial robot.

As further depicted, in particular embodiments, the cable management drive system 202 may include a number of drive wheels 210A, 210B that may be coupled to a drive mechanism 212 and utilized to cause the cable bundle 208 to be extended and retracted. For example, in one embodiment, the cable bundle 208 may be extended from the storage container 102 to facilitate a deployment of the mobile industrial robot to perform a manufacturing and production service or other similar service. In another embodiment, the cable bundle 208 may be retracted into the storage container 102 to facilitate a withdrawal of the mobile industrial robot upon performance of the manufacturing and production service or other similar service.

As further depicted, in particular embodiments, the driver system 204 may be utilized to drive and control the cable management drive system 202. For example, in particular embodiments, the driver system 204 may be coupled to the number of drive wheels 210A, 210B and the drive mechanism 212. Specifically, in particular embodiments, the driver system 204 may be utilized to power the number of drive wheels 210A, 210B and the drive mechanism 212 to cause the cable bundle 208 to be extended and retracted with respect to the storage container 102 and the attached mobile industrial robot. In particular embodiments, the drive mechanism 212 may include, for example, a drive belt, a drive chain, a drive gear box, or other suitable drive mechanism. In some embodiments, the driver system 204 may include a mechanical crank 216 (e.g., manual crank mechanism) that may be suitable for allowing an operator of the cable management drive system 202 to manually drive and control the number of drive wheels 210A, 210B and the drive mechanism 212 and cause the cable bundle 208 to be extended and retracted.

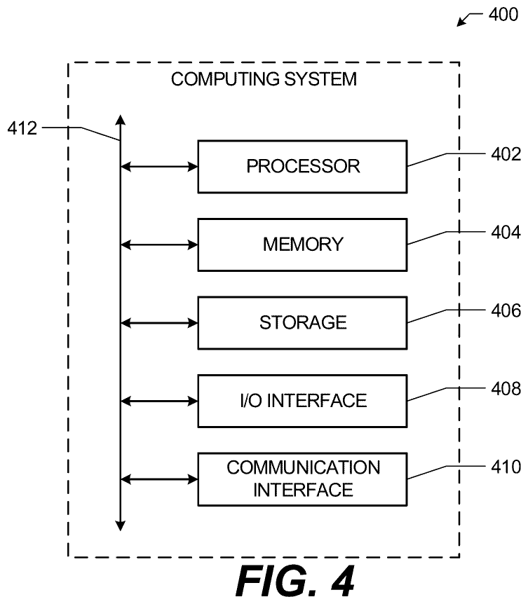

In other embodiments, the driver system 204 may include a motor 218 that may be suitable for automatically driving and controlling the number of drive wheels 210A, 210B and the drive mechanism 212 to cause the cable bundle 208 to be extended and retracted. In one embodiment, the motor 218 may be an electric motor (e.g., a single-phase electric motor or a three-phase electric motor). In another embodiment, the motor 218 may include a pneumatic motor. In particular embodiments, the control system 206 may include any computing system (e.g., computing system 400 as discussed below with respect to FIG. 4) or electronic system that may be suitable for providing one or more control signals (e.g., activation signal, deactivation signal, speed signal, pneumatic signal, and so forth) to the driver system 204 to control an operation of, for example, the motor 218. In particular embodiments, as further illustrated, the cable management drive system 202 may include a number of release levers 214A, 214B that may include a mechanism suitable for dynamically deactivating or reconfiguring the number of drive wheels 210A, 210B to further allow manual operation of the driver system 204.

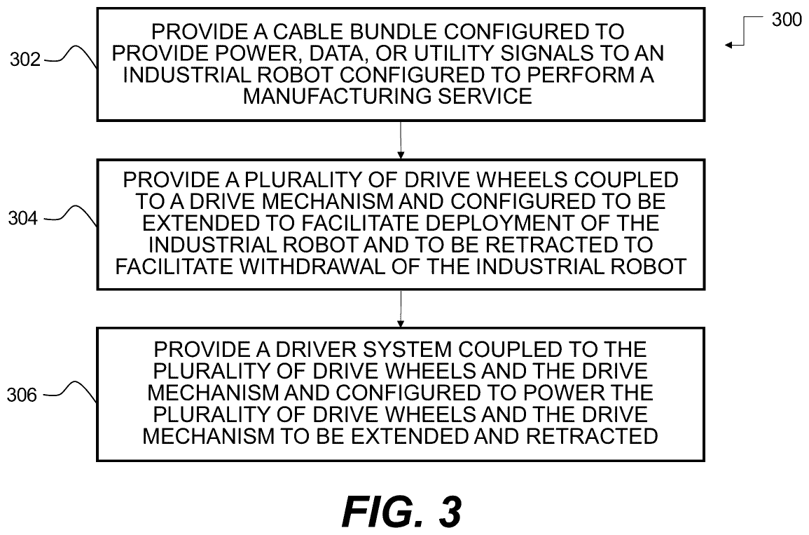

FIG. 3 illustrates a flow diagram of a method 300 for providing a cable management drive system for efficiently extending and retracting cable bundles, in accordance with the presently disclosed embodiments. The method 300 may begin at block 302 with providing a cable bundle configured to provide one or more power signals, data signals, or utility signals to an industrial robot configured to perform a manufacturing service. For example, in particular embodiments, the provided cable bundle may be configured to couple to the industrial robot. The method 300 may continue at block 304 with providing a plurality of drive wheels coupled to a drive mechanism and configured to cause the cable bundle to be extended to facilitate a deployment of the industrial robot to perform the manufacturing service and to be retracted to facilitate a withdrawal of the industrial robot upon performance of the manufacturing service.

The method 300 may then conclude at block 306 with providing a driver system coupled to the plurality of drive wheels and the drive mechanism. For example, in particular embodiments, the provided driver system may be configured to power the plurality of drive wheels and the drive mechanism to cause the cable bundle to be extended and retracted. In this way, the present embodiments thus allow for mobile robots including cable bundles (e.g., long tubular multi-axis cable carriers) to be efficiently and compactly deployed.

FIG. 4 illustrates an example computer system 400 that may be useful in performing one or more of the foregoing techniques as presently disclosed herein. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein.

As an example, and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate. In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example, and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example, and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402.

Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 602. Although this disclosure describes and illustrates a particular processor, this disclosure contemplates any suitable processor.

In particular embodiments, memory 404 includes main memory for storing instructions for processor 402 to execute or data for processor 402 to operate on. As an example, and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere).

One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example, and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example, and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it.

As an example, and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A cable management drive system for efficiently extending and retracting cable bundles, comprising:
a cable bundle configured to provide one or more power, data, or utility signals to an industrial robot configured to perform a service, wherein the cable bundle is further configured to couple to the industrial robot;
a plurality of drive wheels coupled to a drive mechanism and configured to cause the cable bundle to be extended to facilitate a deployment of the industrial robot to perform the service and to be retracted to facilitate a withdrawal of the industrial robot upon performance of the service; and
a driver system coupled to the plurality of drive wheels and the drive mechanism, wherein the driver system is configured to power the plurality of drive wheels and the drive mechanism to cause the cable bundle to be extended and retracted.

2. The cable management drive system of claim 1, wherein the cable bundle comprises one or more long tubular multi-axis cable carriers.

3. The cable management drive system of claim 1, further comprising a plurality of release levers configured to dynamically deactivate the plurality of drive wheels to allow manual operation of the driver system.

4. The cable management drive system of claim 1, wherein the driver system comprises a manual crank mechanism.

5. The cable management drive system of claim 1, wherein the driver system comprises a motor.

6. The cable management drive system of claim 1, further comprising a storage container, wherein the cable bundle is configured to extend from the storage container and to retract into the storage container.

7. The cable management drive system of claim 1, wherein the industrial robot comprises a mobile industrial robot, the system further comprising:
a storage container coupled to the mobile industrial robot by way of the cable bundle, wherein the storage container encloses the cable management drive system.

8. A system, comprising:
a storage container;
a cable bundle configured to provide one or more power, data, or utility signals to an industrial robot configured to perform a service, wherein the cable bundle is further configured to couple to the industrial robot;
a plurality of drive wheels coupled to a drive mechanism and configured to cause the cable bundle to be extended from the storage container to facilitate a deployment of the industrial robot to perform the service and to be retracted into the storage container to facilitate a withdrawal of the industrial robot upon performance of the service; and
a driver system coupled to the plurality of drive wheels and the drive mechanism, wherein the driver system is configured to power the plurality of drive wheels and the drive mechanism to cause the cable bundle to be extended and retracted.

9. The system of claim 8, wherein the cable bundle comprises one or more long tubular multi-axis cable carriers.

10. The system of claim 8, further comprising a plurality of release levers configured to dynamically deactivate the plurality of drive wheels to allow manual operation of the driver system.

11. The system of claim 8, wherein the driver system comprises a manual crank mechanism.

12. The system of claim 8, wherein the driver system comprises a motor.

13. The system of claim 8, wherein the storage container is sized based on a length of the cable bundle.

14. A system, comprising:
a cable management drive system, comprising:
a cable bundle configured to provide one or more power, data, or utility signals to an industrial robot configured to perform a service, wherein the cable bundle is further configured to couple to the industrial robot;
a plurality of drive wheels coupled to a drive mechanism and configured to cause the cable bundle to be extended to facilitate a deployment of the industrial robot to perform the service and to be retracted to facilitate a withdrawal of the industrial robot upon performance of the service; and
a driver system coupled to the plurality of drive wheels and the drive mechanism, wherein the driver system is configured to power the plurality of drive wheels and the drive mechanism to cause the cable bundle to be extended and retracted; and
a control system configured to control an operation of the driver system.

15. The system of claim 14, wherein the cable bundle comprises one or more long tubular multi-axis cable carriers.

16. The system of claim 14, wherein the driver system comprises a manual crank mechanism.

17. The system of claim 14, wherein the driver system comprises a motor.

18. The system of claim 14, further comprising a storage container, wherein the cable bundle is configured to extend from the storage container and to retract into the storage container.

19. The system of claim 18, wherein the storage container is sized based on a length of the cable bundle, and wherein the cable management drive system is sized based on a diameter of the cable bundle.

20. The system of claim 19, wherein the storage container encloses the cable management drive system.
